(19) United States
(12) Patent Application Publication
(10) Pub. No.: US 2021/0313687 A1
(43) Pub. Date: Oct. 7, 2021

(54) RADIO TRANSCEIVER WITH ANTENNA ARRAY FORMED BY HORN-ANTENNA ELEMENTS

(71) Applicant: Thomas Kyo Choi, Los Angeles, CA (US)

(72) Inventor: Thomas Kyo Choi, Los Angeles, CA (US)

(21) Appl. No.: 16/840,548

(22) Filed: Apr. 6, 2020

(51) Int. Cl. H01Q 3/34; H01Q 21/20; H01Q 21/06; H01Q 13/02

(52) U.S. Cl. CPC H01Q 3/34; H01Q 13/0208; H01Q 21/064; H01Q 21/205

(57) ABSTRACT

An antenna array formed by horn-antenna elements perpendicularly mounted on a body frame spherical or hemispherical in shape provides a wide field of view (FOV) of at least 180°. A radio transceiver uses the antenna array instead of a phased array antenna for easily tracking a moving object, e.g., a satellite, due to the wide FOV and for receiving an incoming signal therefrom. To steer an outgoing signal along a desired propagation direction, the transceiver transmits the outgoing signal on a preferred antenna element having a boresight direction closest to the desired propagation direction. The outgoing signal is non-mechanically steered and, in contrast to using the phased array antenna, a power amplifier of the radio transceiver needs not generate component signals satisfying precise relationships in phase and amplitude for beam steering. Thus, the power amplifier is allowed to be operated at a lower power backoff for improving power efficiency.

### LIST OF ABBREVIATIONS

FOV Field of view

GEO Geostationary Earth orbit

LEO Low Earth orbit

MEO Medium Earth orbit

RF Radio frequency

UE User equipment

WLAN Wireless local area network

### FIELD OF THE INVENTION

The present invention generally relates to a radio transceiver having an antenna array. In particular, the present invention relates to such radio transceiver with the antenna array formed with a plurality of horn-antenna elements, the radio transceiver being capable of at least steering an outgoing RF signal along a desired propagation direction.

### BACKGROUND

Typically, radio antennas are either directional or omnidirectional. A directional antenna usually has a narrow beam width of a few degrees (as used in microwave and satellite communication) or is sectorized seeing a large area of 30° to 180° (as used in cellular communication). An omnidirectional antenna has a 360° receptivity (as used in mobile phones and WiFi access points). A wider coverage area results in a lower antenna gain. A higher directivity provides a higher antenna gain, allowing a reduction in required output power of a RF amplifier and offering a higher degree of data compression on a radio link so as to overcome a path loss of a communication link between two radio stations.

When one or both of the radio stations are moving, it would be necessary to have either mechanically or electronically steered radio antennas to establish the communication link. Mechanically stabilized antennas on marine vessels and airplanes are such examples in operation currently. Phased array antennas, which create electronically steered RF beams, are deployed for 5G communications and for satellite applications. A mechanically stabilized antenna requires an actuator to position and orient this antenna to point to a desired direction. In one aspect, the actuator is usually bulky and requires a substantial amount of power to operate. In another aspect, maintenance of the mechanically stabilized antenna is not simple due to the presence of moving parts. Although a phased array antenna is advantageous over the mechanically stabilized antenna in these two aspects, there are two drawbacks for the phased array antenna.

The first drawback is that setting the phased array antenna with a FOV of over 60° often results in a significant drop in the antenna gain, thereby severely limiting the ability of the phased array antenna in tracking moving objects. Tracking an airplane or a satellite, which can appear anywhere in the sky, by a terrestrial station is made difficult. Furthermore, the airplane or the satellite equipping with the phased array antenna can only see a narrow FOV. In both cases, to have a FOV wider than 60° or 70°, mechanisms other than using a single phased array antenna are required. These mechanisms include using multiple units of phased array antenna to expand the FOV, or employing some form of mechanical pointing along with the phased array antenna for reducing cost and complexity of having to use more than one phased array antenna. The second drawback is that operating the phased array antenna for beam forming requires a significant amount of electrical power. A large pool of electrical power is not easily accessible on small vehicles or at remote locations where access to power is limited or generally unavailable.

There is a need in the art for a technique of beam steering with the aforementioned two drawbacks being avoided or overcome.

### SUMMARY OF THE INVENTION

A first aspect of the present invention is to provide a radio transceiver having an antenna array with an advantage of overcoming the aforementioned two drawbacks.

The radio transceiver comprises an antenna array, one or more processors, and a transmitter module. The antenna array comprises a body frame and a plurality of horn-antenna elements distributed and mounted on the body frame. The body frame has a shape of at least one half of an ellipsoid. An individual horn-antenna element has a boresight direction. Respective boresight directions provided by the plurality of horn-antenna elements are mutually different. The one or more processors are configured to, upon receipt of a request for transmitting an outgoing RF signal and steering the outgoing RF signal to propagate along a desired propagation direction, select a preferred antenna element from the plurality of horn-antenna elements such that the boresight direction of the preferred antenna element is closest to the desired propagation direction. The transmitter module is controllable by the one or more processors and comprises one or more power amplifiers. The transmitter module is configured to generate the outgoing RF signal by the one or more power amplifiers and to feed the generated outgoing RF signal to the preferred antenna element. It follows that that the outgoing RF signal leaving the antenna array is non-mechanically steered to propagate along the desired propagation direction without a need for the one or more power amplifiers to generate plural component signals satisfying precise relationships among phases and amplitudes thereof for generating and steering the outgoing RF signal. Thereby, the one or more power amplifiers are allowed to be operated at a lower power backoff for improving power efficiency achieved by the one or more power amplifiers when compared to using a phased array antenna instead of the antenna array.

Preferably, the shape of the body frame is hemispherical is spherical.

It is preferable that the individual horn-antenna element is substantially-perpendicularly mounted on the body frame such that the respective boresight directions provided by the plurality of horn-antenna elements are mutually different. It is also preferable that the plurality of horn-antenna elements is distributed on the body frame such that the antenna array provides a FOV of at least 120°.

The individual horn-antenna element may be a pyramidal horn antenna, a corrugated pyramidal horn antenna, a conical horn antenna, or a corrugated conical horn antenna.

In certain embodiments, the transmitter module is further configured to generate plural independent outgoing RF signals, and to send out the independent outgoing RF signals through different antenna elements selected from the plurality of horn-antenna elements for transmitting the independent outgoing RF signals along different propagation directions. The transmitter module may be further configured such that an individual independent outgoing RF signal is generated with a carrier frequency selected from a plurality of different carrier frequencies. The plurality of different carrier frequencies may include carrier frequencies used for 2.4 GHz and 5.2 GHz WiFi services, and/or carrier frequencies in the L band or the S band.

In certain embodiments, the radio transceiver further comprises a receiver module. The receiver module is controllable by the one or more processors for at least receiving an incoming RF signal incident on the radio transceiver through a group of antenna elements in the plurality of horn-antenna elements after the group is identified. The receiver module is configured to receive a signal copy of the incoming RF signal from each antenna element in the identified group, and to combine respective signal copies to reconstruct the incoming RF signal for enhancing a signal-to-noise ratio thereof.

The respective signal copies may be combined by using maximum ratio combining, equal gain combining, or selection combining.

Preferably, the one or more processors are further configured to control the receiver module such that before the group is identified, the receiver module scans a FOV provided by the antenna array for detecting presence of the incoming RF signal and identifying the group. The FOV is created by the plurality of antenna elements distributed on the body frame.

It is also preferable that the one or more processors are further configured to control the receiver module such that after the group is identified, the receiver module tracks a direction of arrival of the incoming RF signal over time so as to regularly update the group with new locations of antenna elements on which the incoming RF signal is incident.

In certain embodiments, the one or more processors are further configured to assign a direction opposite to the direction of arrival as the desired propagation direction for supporting bidirectional wireless communication between the radio transceiver and a mobile communication device that sends out the incoming RF signal.

In certain embodiments, the receiver module is further configured to receive plural independent incoming RF signals through different groups of antenna elements in the plurality of horn-antenna elements. The receiver module may be further configured to receive an individual independent incoming RF signal having a carrier frequency selected from a plurality of different carrier frequencies. The plurality of different carrier frequencies may include carrier frequencies used for 2.4 GHz and 5.2 GHz WiFi services, and/or carrier frequencies in the L band or the S band.

A second aspect of the present invention is to provide a method for steering an outgoing RF signal to propagate along a desired propagation direction.

The method comprises providing an antenna array realized according to any of the embodiments of the antenna array disclosed in the first aspect of the present invention. As a result, the realized antenna array comprises a body frame and a plurality of horn-antenna elements distributed and mounted on the body frame. The body frame has a shape of at least one half of an ellipsoid. An individual horn-antenna element has a boresight direction. Respective boresight directions provided by the plurality of horn-antenna elements are mutually different. Preferably, the shape of the body frame is spherical or hemispherical. The method further comprises: selecting a preferred antenna element from the plurality of horn-antenna elements such that the boresight direction of the preferred antenna element is closest to the desired propagation direction; generating the outgoing RF signal; and feeding the generated outgoing RF signal to the preferred antenna element such that the outgoing RF signal leaving the antenna array is non-mechanically steered to propagate along the desired propagation direction without a burden of generating plural component signals satisfying precise relationships among phases and amplitudes thereof for use by a phased-array antenna to steer the outgoing RF signal.

Other aspects of the present disclosure are disclosed as illustrated by the embodiments hereinafter.

### BRIEF DESCRIPTION OF THE DRAWINGS

FIG. 1 depicts a schematic diagram of a radio transceiver as disclosed herein in accordance with an exemplary embodiment of the present invention, where the radio transceiver includes an antenna array, a transmitter module, a receiver module and one or more processors.

FIG. 2 depicts embodiments of the antenna array as used in the radio transceiver, where the antenna array may be spherical or hemispherical in shape.

FIG. 3 depicts a cross-sectional diagram of an exemplary antenna array shaped as more than one half of an ellipsoid.

FIG. 4 depicts embodiments of horn antenna usable for realizing an antenna element in the antenna array.

FIG. 5 depicts schematic diagrams of two embodiments of the transmitter module for illustrating practical implementation thereof.

FIG. 6 depicts a simplified top view of the plurality of horn-antenna elements on the antenna array for illustrating different groups of antenna elements in receiving incoming RF signals.

FIG. 7 depicts a schematic diagram of an embodiment of the receiver module for illustrating practical implementation thereof.

FIG. 8 depicts a flowchart showing exemplary steps of a method as disclosed herein for steering an outgoing RF signal to propagate along a desired propagation direction.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

As used herein, a FOV specifically means a circular FOV unless otherwise stated. Since a circular FOV has a FOV that appears as a circle, an angle of view subtended from a selected point on the circle to an opposite point on the diameter is the same regardless of the position of the selected point on the circle. The circular FOV can be conveniently and uniquely characterized by the angle of view without a need to mention end positions between which the angle of view is measured.

As used herein, “power backoff” of an amplifier means a difference in power level between the maximum output power deliverable by the amplifier and an output power scheduled to be provided, or actually provided, by the amplifier during normal operation. It follows that the output power actually delivered by the amplifier during operation is the maximum output power minus the power backoff. Since the amplifier is usually operated in a nonlinear region if the maximum output power is delivered, the aim of setting the power backoff is to operate the amplifier at a more linear region so as to reduce signal distortion at the amplifier output.

As mentioned above, there are two drawbacks for the phased antenna array. First, it is difficult to maintain a high antenna gain over an entire FOV if the phased antenna array is steered to have the FOV of over 60°. Second, a significant amount of power is required in steering the phased antenna array.

The second drawback is due to the need to generate a plurality of signal components that satisfy precise relationships among phases and amplitudes of these signal components. These signal components excite respective antenna elements of the phased array antenna to generate and steer the resultant radio beam. Note that the phased array antenna is operated in the radio-beam transmission mode, so that the signal components are generated by a bank of power amplifiers. The bank of power amplifiers is required to operate within a linearity range or with a large power backoff in order that the generated signal components satisfy the precise relationships in phase and amplitude, thereby causing high power consumption and generating a lot of heat in operating the bank of amplifiers in practice. Avoiding the need to generate the plurality of signal components is an aim of the present invention.

Instead of using the phased array antenna, the present invention advantageously uses an antenna array formed by antenna elements each being a horn antenna. Each of these antenna elements is referred to as a horn-antenna element. A horn antenna is a passive antenna that can be tailored to provide a large antenna gain along a boresight direction, a narrow beam width, a high side-lobe rejection, and a wide bandwidth. The boresight direction is usually aligned with a major axis of the horn antenna. By installing a plurality of horn-antenna elements on a curved surface, different horn-antenna elements provide different boresight directions such that selecting an appropriate horn-antenna element for radiating a signal enables beam steering to be performed while only one signal is required to be generated. A power amplifier that generates this signal can be operated in a more nonlinear region than in the case of generating the plurality of signal components for the phased array antenna, thereby overcoming the above-mentioned second drawback. The curved surface on which the plurality of horn-antenna elements is installed is advantageously chosen to be hemispherical or spherical, for example. When each horn-antenna element is substantially-perpendicularly mounted on the curved surface, a wide FOV of at least 180° is achievable. Furthermore, a resultant antenna gain of the antenna array is determined by an antenna gain of an individual horn-antenna element. The latter antenna gain is independent of the boresight direction thereof, and is the same among all the antenna elements in the antenna array provided that the antenna elements are substantially similar, thereby overcoming the above-mentioned first drawback.

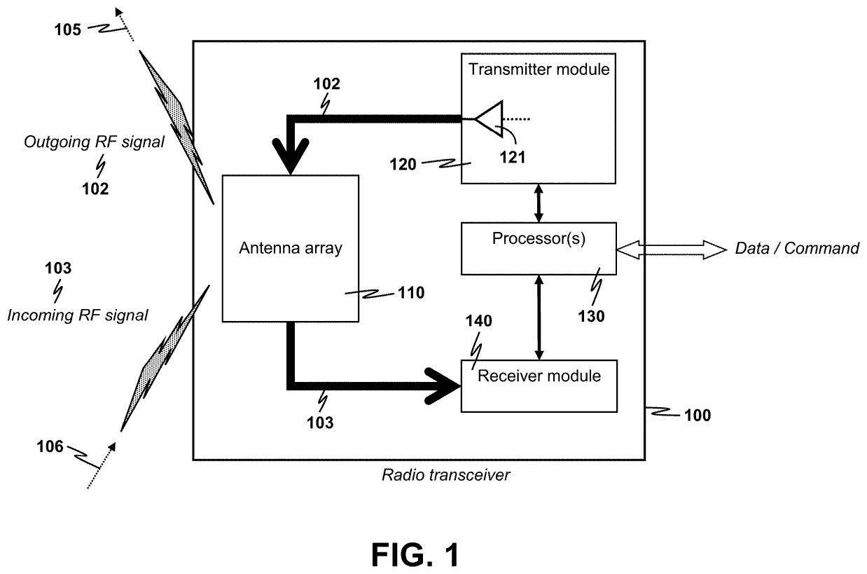

A first aspect of the present invention is to provide a radio transceiver having an antenna array with an advantage of overcoming the above-mentioned two drawbacks. The radio transceiver is exemplarily illustrated with the aid of FIG. 1, which depicts a schematic diagram of a radio transceiver 100 in accordance with an exemplary embodiment of the present invention. The radio transceiver 100 is used for transmitting an outgoing RF signal 102 and steering the outgoing RF signal 102 to propagate along a desired propagation direction 105, as well as for receiving and tracking an incoming RF signal 103 arrived from a direction of arrival 106.

The radio transceiver 100 comprises an antenna array 110 for sending out the outgoing RF signal 102 and receiving the incoming RF signal 103.

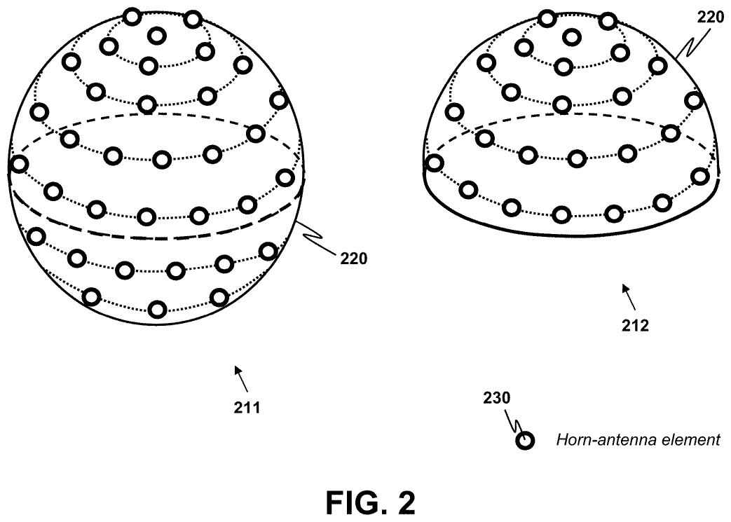

FIG. 2 depicts two preferable embodiments of the antenna array 110. A first antenna array 211 is spherical in shape, and a second antenna array 212 is hemispherical. Each of the first and second antenna arrays 211, 212 is formed with a body frame 220 and a plurality of horn-antenna elements 230 distributed and mounted on the body frame 220. The body frame 220 is a rigid structure for at least supporting the plurality of horn-antenna elements 230. For the first and second antenna arrays 211, 212, shapes of the body frame 220 are spherical and hemispherical, respectively. As FIG. 2 shows an example that the plurality of horn-antenna elements 230 is uniformly distributed over the body frame 220, FOVs offered by the first and second antenna arrays 211, 212 are approximately 360° and 180°, respectively. Note that the first and second antenna arrays 211, 212 are special cases of the body frame 220 being a portion of an ellipsoid. To provide a FOV of at least 180°, the body frame 220 has a shape of at least one half of an ellipsoid.

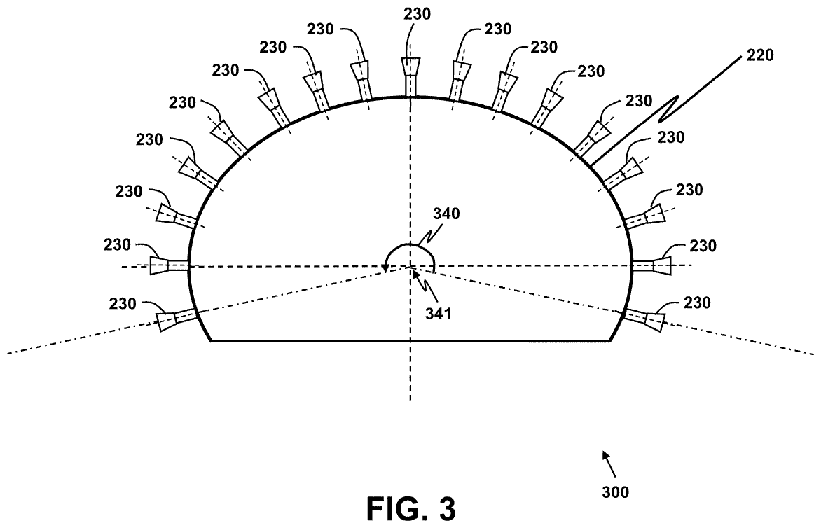

FIG. 3 depicts a cross-sectional diagram of a third antenna array 300 with the body frame 220 having a shape of more than one half of an ellipsoid. The third antenna array 300 is an exemplary embodiment of the antenna array 110, and is also a generalization of the first and second antenna arrays 211, 212. In the third antenna array 300, the plurality of horn-antenna elements 230 is mounted on the body frame 220. An individual horn-antenna element in the plurality of horn-antenna elements 230 has a boresight direction, which is a direction of maximum antenna gain provided by the individual horn-antenna element. Advantageously and preferably, the individual horn-antenna element is substantially-perpendicularly mounted on the body frame 220. It follows that respective boresight directions provided by the plurality of horn-antenna elements 230 are mutually different. Each of individual horn-antenna elements 230 provides a portion of a FOV 340 offered by the third antenna array 300. Practically, the overall FOV 340 is measured by an angle of view seen from a center 341 of the ellipsoid used in defining the body frame 220.

It is advantageous to uniformly distribute the plurality of horn-antenna elements 230 over the entire exterior surface of the body frame 220 in order to create the largest possible FOV, although the coverage of the plurality of horn-antenna elements 230 on the body frame 220 may be reduced due to other consideration as deemed appropriate by those skilled in the art according to practical situations. Generally, it is preferable that the plurality of horn-antenna elements 230 is distributed on the body frame 220 such that the third antenna array 300 provides the FOV 340 of at least 120°, more preferably at least 180°. A hemispherical arrangement of the plurality of horn-antenna elements 230 on the body frame 220 enables a ground station to track all moving objects above the ground by using the third antenna array 300, which has a 180° FOV in azimuth and elevation. The hemispherical arrangement of the plurality of horn-antenna elements 230 installed on a satellite traveling on a LEO or a MEO provides a 180° FOV such that the satellite is able to communicate with a ground station or a moving station installed with a high-gain antenna. The third antenna array 300, with a spherical arrangement of the plurality of horn-antenna elements 230 on the body frame 220, can be installed on a tail of an airplane. It enables the airplane flying in the sky to receive and transmit to fixed or moving ground stations, other airplanes or satellites in space. The third antenna array 300 with this spherical arrangement installed on a satellite traveling on a LEO or a MEO enables the satellite to communicate with fixed or moving ground stations or other satellites or other space vehicles in a LEO, a MEO, the GEO or orbits beyond the GEO.

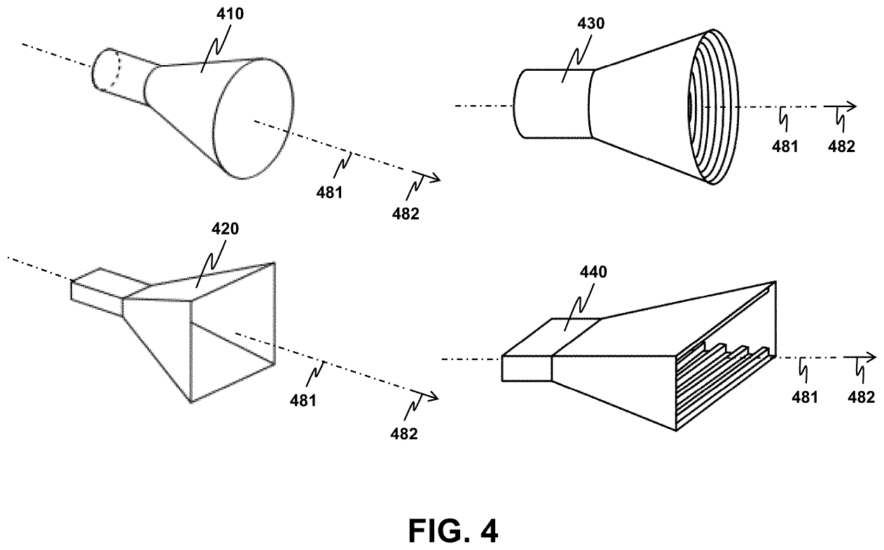

FIG. 4 depicts some practical horn antennas as embodiments usable for realizing the individual horn-antenna element of the third antenna array 300. Such horn antennas include a conical horn antenna 410, a pyramidal horn antenna 420, a corrugated conical horn antenna 430 and a corrugated pyramidal horn antenna 440. Usually, a major axis 481 of each of the aforementioned horn antennas 410, 420, 430, 440 coincides with a boresight direction 482 thereof.

Refer to FIG. 1. The radio transceiver 100 further comprises one or more processors 130 and a transmitter module 120 controllable by the one or more processors 130. The transmitter module 120 comprises one or more power amplifiers 121. The one or more processors 130 and the transmitter module 120 are configured as follows. When the one or more processors 130 receive a request for transmitting the outgoing RF signal 102 and steering the outgoing RF signal 102 to propagate along the desired propagation direction 105 is received, the one or more processors 130 select or determine a preferred antenna element from the plurality of horn-antenna elements 230 such that the boresight direction of the preferred antenna element is closest to the desired propagation direction 105. The one or more processors 130 control the transmitter module 120 to generate the outgoing RF signal 102 and to feed the generated outgoing RF signal 102 to the preferred antenna element. In particular, the one or more power amplifiers 121 of the transmitter module 120 are used to generate the outgoing RF signal 102. Advantageously, the outgoing RF signal 102 leaving the antenna array 110 is non-mechanically steered to propagate along the desired propagation direction 105 without a need for the one or more power amplifiers 121 to generate plural component signals satisfying precise relationships among phases and amplitudes thereof for generating and steering the outgoing RF signal 102. By using the disclosed antenna array 110 instead of a phased array antenna, the aforementioned advantage frees the one or more power amplifiers 121 installed in the transmitter module 120 from requiring to be operated in a more linear region. Thereby, the one or more power amplifiers 121 are allowed to be operated at a lower power backoff when compared to a case of using the phased array antenna instead of the disclosed antenna array 110 in the radio transceiver 100. Operating the one or more power amplifiers 121 at the lower power backoff improves power efficiency achieved by the one or more power amplifiers 121. Correspondingly, it leads to a reduction in power consumption and heat generation.

As a remark, US 2008/0238797 discloses a spherical arrangement of horn antennas to form a spherical antenna array. While the antenna array disclosed in US 2008/0238797 is mainly configured to provide beamforming and beam steering, the present invention advances the use of spherical, hemispherical and ellipsoidal arrays with horn-antenna elements for lowering a power backoff of power amplifiers while providing a large FOV.

The radio transceiver 100 may be advantageously used for simultaneously supporting multiple communication links. For instance, simultaneous support of satellite communication and terrestrial communication (e.g., over a WLAN) can be accomplished by the radio transceiver 100 having a greater than 180° FOV. The radio transceiver 100 may be practically used as a radio relay in relaying messages between a satellite and a UE operated on a WLAN. In certain embodiments, the transmitter module 120 is further configured to generate plural independent outgoing RF signals, and to send out the independent outgoing RF signals through different antenna elements selected from the plurality of horn-antenna elements 230 for transmitting the independent outgoing RF signals along different propagation directions. The transmitter module 120 may be further configured such that an individual independent outgoing RF signal is generated with a carrier frequency selected from a plurality of different carrier frequencies. In certain embodiments, the plurality of different carrier frequencies includes carrier frequencies used for 2.4 GHz and 5.2 GHz WiFi services, and/or carrier frequencies in the L band or the S band for satellite communication. The L band covers a range of frequencies in the radio spectrum from 1 GHz to 2 GHz. The S band has a frequency range of 2 GHz to 4 GHz.

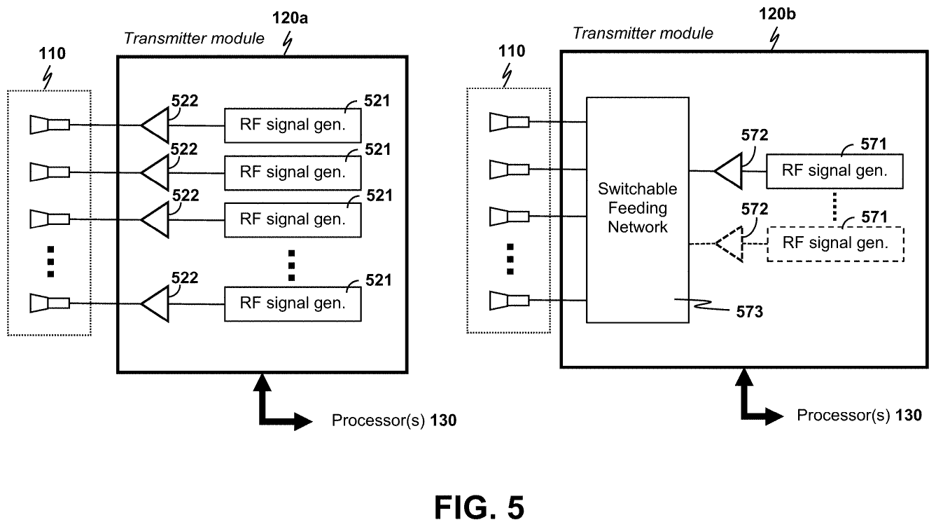

FIG. 5 depicts schematic diagrams of two embodiments of the transmitter module 120 for illustrating practical implementation thereof. A first transmitter module 120a comprises a plurality of RF signal generators 521 and a plurality of power amplifiers 522. A serial cascade of one RF signal generator and one power amplifier is used to generate a RF signal for feeding to a horn-antenna element in the antenna array 110. One serial cascade is uniquely used to feed a respective RF signal to one horn-antenna element in the antenna array 110. The plurality of RF signal generators 521 receives control and data from the one or more processors 130 such that an appropriate RF signal generator corresponding to the preferred antenna element is selected for generating the outgoing RF signal 102. If it is intended that only one or a small number of independent outgoing RF signals are generated simultaneously, duplication of hardware in the first transmitter module 120a, especially the power amplifiers 522, is reducible by using a second transmitter module 120b. The second transmitter module 120b comprises one or more cascades each formed by a RF signal generator 571 and a power amplifier 572. Hence, the second transmitter module 120b is formed with one or more RF signal generators 571 and one or more power amplifiers 572. Each cascade may be configured to generate one independent outgoing RF signal in case multiple outgoing RF signals are intended to be transmitted simultaneously. The one or more generated RF signals are fed to a switchable feeding network 573 for routing the generated signal(s) to appropriate horn-antenna element(s) in the antenna array 110. The switchable feeding network 573 and the one or more RF signal generators 571 receive control and data from the one or more processors 130. Note that the first and second transmitter modules 120a, 120b are disclosed herein merely for illustrating possible realizations of the transmitter module 120. Those skilled in the art will appreciate that other practical realizations of the transmitter module 120 are possible and can be designed based on knowledge in the art.

The radio transceiver 100 further comprises a receiver module 140 for receiving and tracking the incoming RF signal 103. Since the incoming RF signal 103 arrives at the antenna array 110 from the direction of arrival 106, not all antenna elements of the antenna array 110 are able to capture the incoming RF signal 103. Only a group of antenna elements in the plurality of horn-antenna elements 230 receives the incoming RF signal 103. Whether the individual horn-antenna element is able to capture the incoming RF signal depends on the boresight direction and beam width of the individual horn-antenna element as well as the direction of arrival 106. The group of antenna elements can then be identified. The receiver module 140 is controllable by the one or more processors 130 for at least receiving the incoming RF signal 103 incident on the radio transceiver 100 through the group of antenna elements after the group is identified.

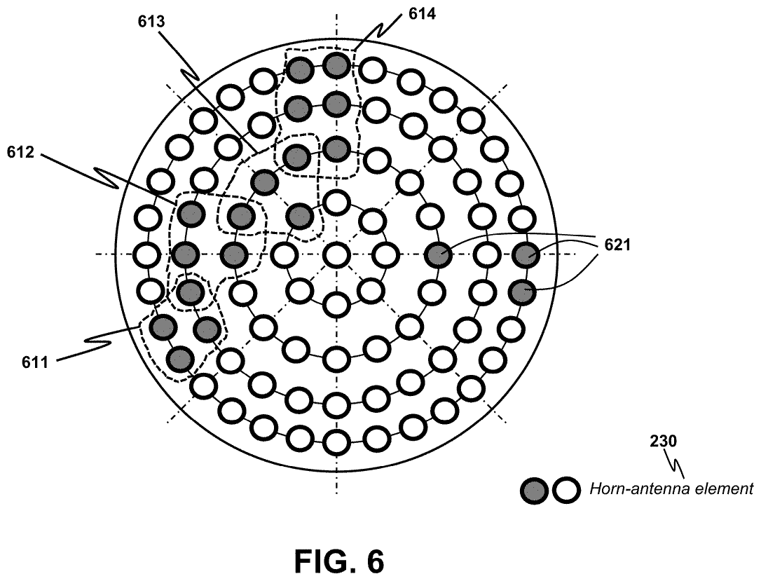

As an example for illustration, FIG. 6 depicts a simplified top view of the plurality of horn-antenna elements 230 on the antenna array 110. A first group 611 of antenna elements is identified to receive the incoming RF signal 103 at a first time instant. Although four neighboring antenna elements are identified in the first antenna-element group 611, it is not always the case. A cluster of neighboring antenna elements is usually identified for satellite communication since (1) a line-of-sight path between the radio transceiver 100 and a satellite under communication exists, causing the direction of arrival 106 to be definite, and (2) the boresight directions of neighboring antenna elements are close. In case of terrestrial mobile communication, multipath propagation is usually dominant, causing directions of arrival to be different for different paths so that a group of scattered antenna elements may be identified (e.g., a group 621 of antenna elements).

After the group of antenna elements is identified, the receiver module 140 is configured to receive a signal copy of the incoming RF signal 103 from each antenna element in the identified group, and to combine respective signal copies to reconstruct the incoming RF signal 103 for enhancing a signal-to-noise ratio of the reconstructed incoming RF signal 103. The respective signal copies may be combined by using one of conventional techniques, such as maximum ratio combining, equal gain combining and selection combining.

Before the group is identified, the receiver module 140 is required to scan a FOV provided by the antenna array 110 for detecting presence of the incoming RF signal 103 and identifying the group. In certain embodiments, the one or more processors 130 are further configured to control the receiver module 140 to scan the FOV to detect presence of the incoming RF signal 103 and also identifying the group in order to facilitate subsequent reception and combination of the respective signal copies to obtain the reconstructed incoming RF signal 103.

During receiving and combining the respective signal copies, continuous tracking of the direction of arrival 106 is required. Tracking of the direction of arrival 106 is especially important for communication with LEO or MEO satellites. In certain embodiments, the one or more processors 130 are further configured to control the receiver module 140 to, after the group is identified, track the direction of arrival 106 of the incoming RF signal 103 over time. It follows that the group is regularly updated with new locations of antenna elements on which the incoming RF signal 103 is incident. As an example of tracking shown in FIG. 6, after the first group 611 of antenna elements is identified at the first time instant, the changing direction of arrival causes the antenna elements that receive the incoming RF signal 103 at subsequent time instants to change from the first group 611 to a second group 612, then a third group 613 and finally to a fourth group 614, after which the direction of arrival 106 falls beyond the FOV or a line-of-sight path on which the incoming RF signal 103 travels may be blocked, e.g., by terrain. Usually, one or more common antenna elements are found in adjacent groups.

In bidirectional communication, usually the outgoing RF signal 102 is steered towards a direction opposite to the direction of arrival 106 of the incoming RF signal 103. In certain embodiments, the one or more processors 130 are further configured to assign a direction opposite to the direction of arrival 106 as the desired propagation direction 105 for supporting bidirectional wireless communication between the radio transceiver 100 and a mobile communication device that sends out the incoming RF signal 103. An example of the mobile communication device is a satellite on a LEO or MEO.

As mentioned above, the radio transceiver 100 may be advantageously used for simultaneously supporting multiple communication links. The receiver module 140 is further configured to receive plural independent incoming RF signals through different groups of antenna elements in the plurality of horn-antenna elements 230 (such as the antenna-element groups 611, 621). The receiver module 140 may be further configured to receive an individual independent incoming RF signal having a carrier frequency selected from a plurality of different carrier frequencies. In certain embodiments, the plurality of different carrier frequencies includes carrier frequencies used for 2.4 GHz and 5.2 GHz WiFi services, and/or carrier frequencies in the L band or the S band for satellite communication.

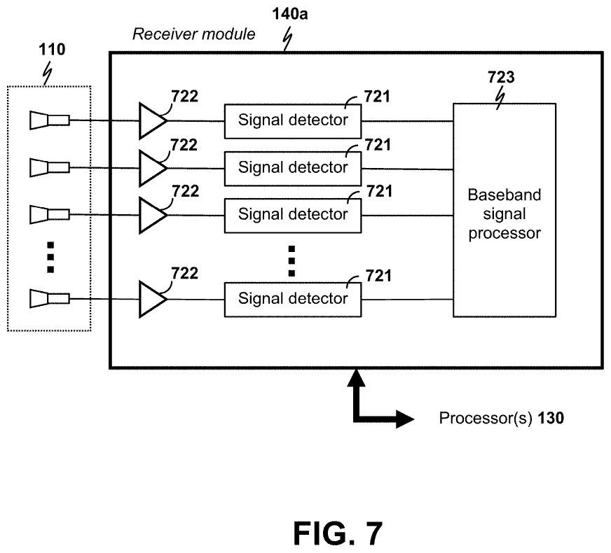

FIG. 7 depicts a schematic diagram of an embodiment of the receiver module 140 for illustrating practical implementation thereof. A first receiver module 140a comprises a plurality of RF front-end amplifiers 722, a plurality of signal detectors 721 and a baseband signal processor 723. A serial cascade of one RF front-end amplifier and one signal detector is used to process a RF signal received by one antenna element of the antenna array 110, and to recover a data-carrying baseband signal carried in the RF signal by RF filtering, down conversion, sampling, etc. Data-carrying baseband signals received from different antenna elements in the antenna array 110 are processed by the baseband signal processor 723 to perform various signal-processing functions for enhancing a signal-to-noise ratio of the reconstructed incoming RF signal 103, such as signal combining. The baseband signal processor 723 and the plurality of signal detectors 721 communicate with the one or more processors 130 for commands and data. Note that the first receiver module 140a is disclosed herein merely for illustrating a possible realization of the receiver module 140. Those skilled in the art will appreciate that other practical realizations of the receiver module 140 are possible and can be designed based on knowledge in the art.

In realizing the radio transceiver 100, an individual processor for realizing the one or more processors 130 may be a microcontroller, a general-purpose processor, or a special-purpose processor such as an application specific integrated circuit or a digital signal processor, or by reconfigurable logics such as a field programmable gate array.

A second aspect of the present invention is to provide a method for steering an outgoing RF signal to propagate along a desired propagation direction. The method is developed in parallel to the development of the radio transceiver as detailed in the first aspect of the present invention.

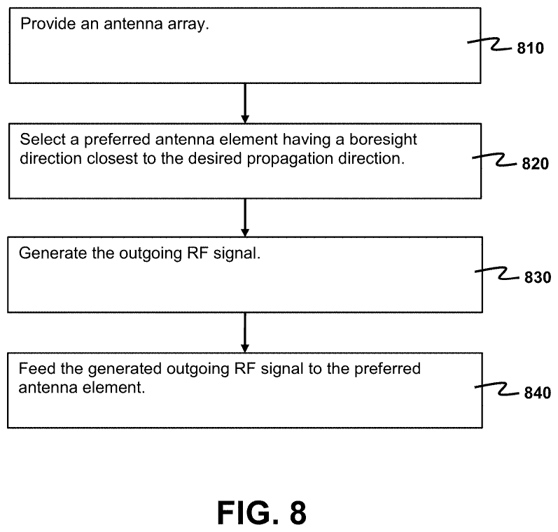

FIG. 8 depicts a flowchart showing exemplary steps of the method. The method comprises steps 810, 820, 830 and 840.

In the step 810, an antenna array realized according to any of the disclosed embodiments of the antenna array 110 is provided. As a result, the realized antenna array comprises a body frame and a plurality of horn-antenna elements distributed and mounted on the body frame. The body frame has a shape of at least one half of an ellipsoid. An individual horn-antenna element has a boresight direction. Respective boresight directions provided by the plurality of horn-antenna elements are mutually different. Preferably, the shape of the body frame is spherical or hemispherical.

In the step 820, a preferred antenna element is selected from the plurality of horn-antenna elements such that the boresight direction of the preferred antenna element is closest to the desired propagation direction.

The outgoing RF signal is generated in the step 830.

The generated outgoing RF signal is fed to the preferred antenna element in the step 840. The outgoing RF signal leaving the antenna array is non-mechanically steered to propagate along the desired propagation direction. Advantageously, a burden of generating plural component signals satisfying precise relationships among phases and amplitudes thereof is avoided. These component signals would otherwise be required if, instead of the antenna array obtained in the step 810, a phased array antenna were used. By using the antenna array obtained in the step 810 rather than the phased array antenna, when one or more power amplifiers are used to generate the outgoing RF signal in the step 830, the one or more power amplifiers are allowed to be operated at a lower power backoff for improving power efficiency achieved by the one or more power amplifiers.

While exemplary embodiments have been presented in the foregoing detailed description of the invention, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of steps and method of operation described in the exemplary embodiment without departing from the scope of the invention as set forth in the appended claims.

What is claimed is:

1. A radio transceiver comprising:
an antenna array comprising a body frame and a plurality of horn-antenna elements distributed and mounted on the body frame, the body frame having a shape of at least one half of an ellipsoid, an individual horn-antenna element having a boresight direction, respective boresight directions provided by the plurality of horn-antenna elements being mutually different;
one or more processors configured to, upon receipt of a request for transmitting an outgoing radio frequency (RF) signal and steering the outgoing RF signal to propagate along a desired propagation direction, select a preferred antenna element from the plurality of horn-antenna elements such that the boresight direction of the preferred antenna element is closest to the desired propagation direction; and
a transmitter module controllable by the one or more processors and comprising one or more power amplifiers, wherein the transmitter module is configured to generate the outgoing RF signal by the one or more power amplifiers and to feed the generated outgoing RF signal to the preferred antenna element such that the outgoing RF signal leaving the antenna array is non-mechanically steered to propagate along the desired propagation direction without a need for the one or more power amplifiers to generate plural component signals satisfying precise relationships among phases and amplitudes thereof for generating and steering the outgoing RF signal.

2. The radio transceiver of claim 1, wherein the plurality of horn-antenna elements is distributed on the body frame such that the antenna array provides a field of view (FOV) of at least 120°.

3. The radio transceiver of claim 1, wherein the shape of the body frame is hemispherical.

4. The radio transceiver of claim 1, wherein the shape of the body frame is spherical.

5. The radio transceiver of claim 1, wherein the individual horn-antenna element is a pyramidal horn antenna or a corrugated pyramidal horn antenna.

6. The radio transceiver of claim 1, wherein the individual horn-antenna element is a conical horn antenna or a corrugated conical horn antenna.

7. The radio transceiver of claim 1, wherein the transmitter module is further configured to:
generate plural independent outgoing RF signals; and
send out the independent outgoing RF signals through different antenna elements selected from the plurality of horn-antenna elements for transmitting the independent outgoing RF signals along different propagation directions.

8. The radio transceiver of claim 7, wherein the transmitter module is further configured such that an individual independent outgoing RF signal is generated with a carrier frequency selected from a plurality of different carrier frequencies.

9. The radio transceiver of claim 1 further comprising:
a receiver module controllable by the one or more processors for at least receiving an incoming RF signal incident on the radio transceiver through a group of antenna elements in the plurality of horn-antenna elements after the group is identified, wherein the receiver module is configured to receive a signal copy of the incoming RF signal from each antenna element in the identified group, and to combine respective signal copies to reconstruct the incoming RF signal for enhancing a signal-to-noise ratio thereof.

10. The radio transceiver of claim 9, wherein maximum ratio combining is used to combine the respective signal copies.

11. The radio transceiver of claim 9, wherein the one or more processors are further configured to control the receiver module to:
before the group is identified, scan a field of view (FOV) provided by the antenna array for detecting presence of the incoming RF signal and identifying the group, wherein the FOV is created by the plurality of antenna elements distributed on the body frame.

12. The radio transceiver of claim 9, wherein the one or more processors are further configured to control the receiver module to:
after the group is identified, track a direction of arrival of the incoming RF signal over time so as to regularly update the group with new locations of antenna elements on which the incoming RF signal is incident.

13. The radio transceiver of claim 12, wherein the one or more processors are further configured to assign a direction opposite to the direction of arrival as the desired propagation direction for supporting bidirectional wireless communication between the radio transceiver and a mobile communication device that sends out the incoming RF signal.

14. The radio transceiver of claim 9, wherein the receiver module is further configured to:
receive plural independent incoming RF signals through different groups of antenna elements in the plurality of horn-antenna elements.

15. A method for steering an outgoing radio frequency (RF) signal to propagate along a desired propagation direction, the method comprising:
providing an antenna array, the antenna array comprising a body frame and a plurality of horn-antenna elements distributed and mounted on the body frame, the body frame having a shape of at least one half of an ellipsoid, an individual horn-antenna element having a boresight direction, respective boresight directions provided by the plurality of horn-antenna elements being mutually different;
selecting a preferred antenna element from the plurality of horn-antenna elements such that the boresight direction of the preferred antenna element is closest to the desired propagation direction;
generating the outgoing RF signal; and
feeding the generated outgoing RF signal to the preferred antenna element such that the outgoing RF signal leaving the antenna array is non-mechanically steered to propagate along the desired propagation direction without a burden of generating plural component signals satisfying precise relationships among phases and amplitudes thereof for use by a phased-array antenna to steer the outgoing RF signal.
